(19) United States
(12) Patent Application Publication
(10) Pub. No.: US 2020/0328652 A1
(43) Pub. Date: Oct. 15, 2020

(54) DRIVE APPARATUS

(71) Applicant: NIDEC CORPORATION, Kyoto (JP)

(72) Inventors: Takahiro MIKI, Kyoto (JP); Shuhei NAKAMATSU, Kyoto (JP); Keisuke FUKUNAGA, Kyoto (JP)

(21) Appl. No.: 16/835,150

(22) Filed: Mar. 30, 2020

(30) Foreign Application Priority Data
Apr. 11, 2019 (JP) 2019-075219

(51) Int. Cl. H02K 5/24; F16H 57/028; F16H 57/04; B60K 1/00; H02K 5/20; H02K 7/00; H02K 7/116; H02K 11/33

(52) U.S. Cl. CPC H02K 5/24; F16H 57/028; F16H 57/0412; B60K 1/00; F16H 2057/02034; H02K 7/006; H02K 7/116; H02K 11/33; B60K 2001/006; H02K 5/20

(57) ABSTRACT

A drive apparatus includes a motor, a speed reduction mechanism, a power converter, and a housing arranged to house the motor, the speed reduction mechanism, and the power converter. The housing includes a first housing and a second housing. The first housing is arranged to house the motor. The second housing is arranged to cover an opening of the first housing, and hold the power converter between the first housing and the second housing. The second housing includes a peripheral portion fixed to the first housing, and a bottom portion arranged to extend inside of the peripheral portion. The bottom portion is arranged to have a non-flat vibration suppression structure.

### CROSS-REFERENCE TO RELATED APPLICATIONS

The present invention claims priority under 35 U.S.C. § 119 to Japanese Application No. 2019-075219 filed on Apr. 11, 2019 the entire content of which is incorporated herein by reference.

### FIELD OF THE INVENTION

The present invention relates to a drive apparatus.

### BACKGROUND

A drive apparatus including a motor as a power source is often installed in a vehicle such as, for example, an electric vehicle or a plug-in hybrid vehicle. A known drive apparatus includes a drive apparatus case arranged to house a motor, and an inverter case arranged to house an inverter, a smoothing capacitor, and a control device. The inverter case is fixed to a top wall of the drive apparatus case. In addition, the inverter case is made up of a tubular frame and a cover arranged on the frame.

In the case of the structure of this known drive apparatus, the cover, which is arranged to cover the frame, is necessary in addition to the frame, which is arranged to hold the inverter, the smoothing capacitor, and the control device. It is therefore difficult to achieve a reduced size of the drive apparatus. One conceivable method for achieving a reduced size of the drive apparatus is to prepare a single member capable of implementing both the function of the frame, i.e., the function of holding the inverter, the smoothing capacitor, and the control device, and the function of the cover, i.e., the function of covering an upper surface of the case.

However, in the case where both the function of the frame and the function of the cover are implemented by a single member, a flat member that implements the function of the cover is arranged to hold the inverter, the smoothing capacitor, and the control device. If this flat member vibrates during use of the drive apparatus, a vibration will reach the inverter, the smoothing capacitor, and the control device, and may cause noise.

### SUMMARY

A drive apparatus according to a preferred embodiment of the present invention includes a motor; a speed reduction mechanism arranged to reduce a speed of rotational motion outputted from the motor; a power converter arranged to convert power inputted from an outside, and supply the converted power to the motor; and a housing arranged to house the motor, the speed reduction mechanism, and the power converter. The housing includes a first housing arranged to house the motor, and including an opening; and a second housing arranged to cover the opening of the first housing, and hold the power converter between the first housing and the second housing. The second housing includes a peripheral portion fixed to the first housing, and a bottom portion arranged to extend inside of the peripheral portion. The bottom portion is arranged to have a non-flat vibration suppression structure.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a drive apparatus according to a preferred embodiment of the present invention.

FIG. 2 is a front view of the drive apparatus.

FIG. 3 is a top view of the drive apparatus.

FIG. 4 is a right side view of the drive apparatus.

FIG. 5 is a left side view of the drive apparatus.

FIG. 6 is a vertical sectional view of a second housing according to a preferred embodiment of the present invention.

### DETAILED DESCRIPTION

Hereinafter, preferred embodiments of the present invention will be described with reference to the accompanying drawings. In the following description, a “vertical direction”, a “front-rear direction”, and a “left-right direction” of a drive apparatus 1 according to a preferred embodiment of the present invention when installed in a vehicle are used to describe the shapes of various members or portions and relative positions of different members or portions. The “left-right direction” corresponds to a width direction of the vehicle, and left and right sides are defined with reference to the vehicle when facing forward. It should be noted, however, that the orientation of the installed drive apparatus 1 with respect to the vehicle is not necessarily limited to the example of this preferred embodiment.

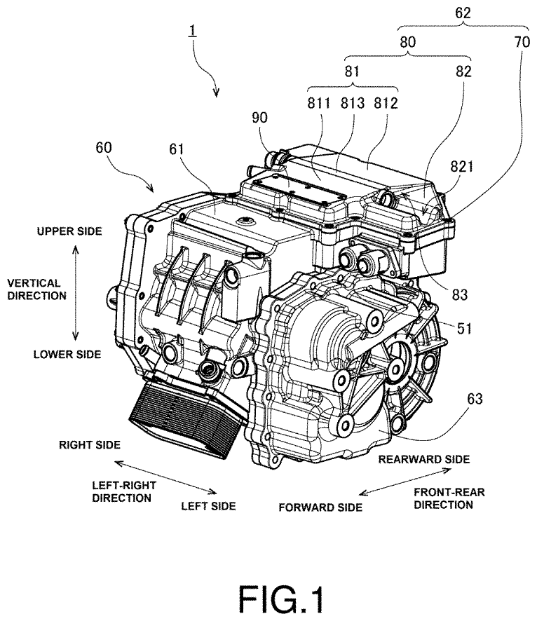

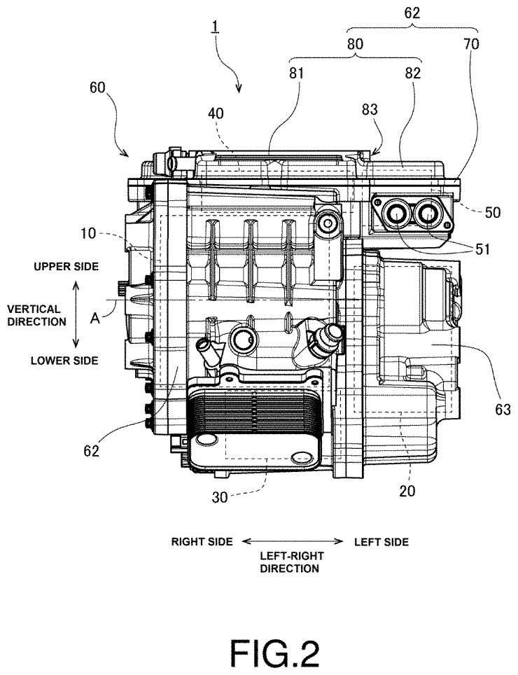

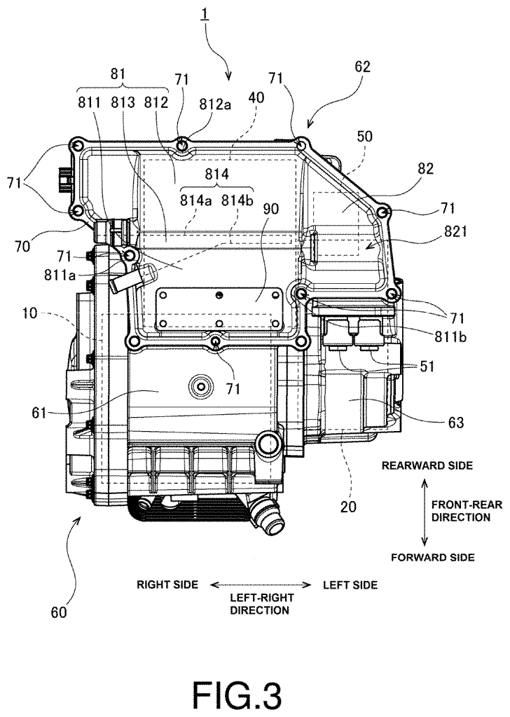

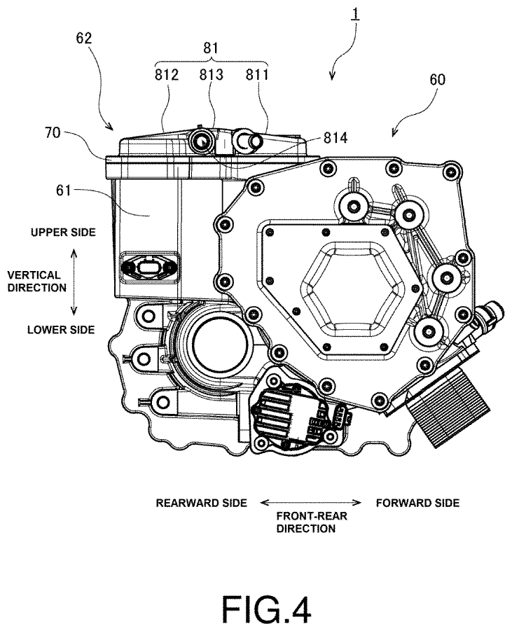

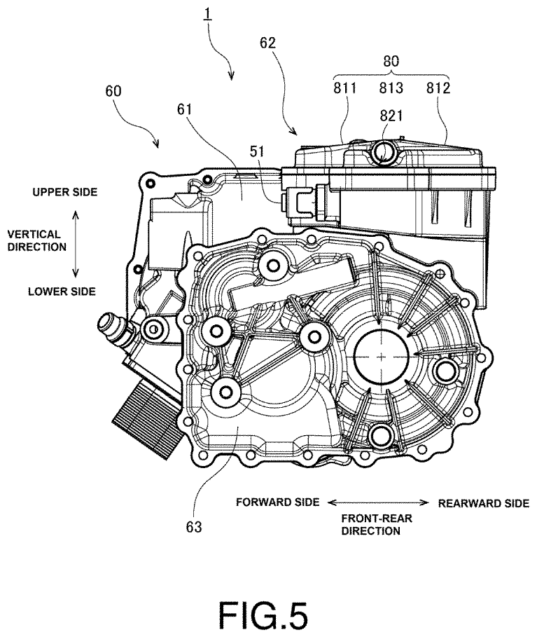

FIG. 1 is a perspective view of the drive apparatus 1 according to a preferred embodiment of the present invention. FIG. 2 is a front view of the drive apparatus 1. FIG. 3 is a top view of the drive apparatus 1. FIG. 4 is a right side view of the drive apparatus 1. FIG. 5 is a left side view of the drive apparatus 1. This drive apparatus 1 is an apparatus (i.e., a traction motor) to be installed in a vehicle such as, for example, an electric vehicle or a plug-in hybrid vehicle to output a driving force to cause the vehicle to travel.

Referring to FIGS. 1 to 5, the drive apparatus 1 according to the present preferred embodiment includes a motor 10, a speed reduction mechanism 20, an oil pump 30, a power converter 40, an electrical component 50, and a housing 60.

The motor 10 is a device to produce rotational motion centered on a rotation axis A extending in the left-right direction. The motor 10 includes a stator and a rotor. The stator is fixed to the housing 60 directly or with another member intervening therebetween. The rotor is supported to be rotatable with respect to the stator. The stator includes a plurality of coils arranged in an annular shape with the rotation axis A in a center. The rotor includes a plurality of magnets arranged in an annular shape with the rotation axis A in a center. Once electric drive currents are supplied from the power converter 40 to the coils, action of a rotating magnetic field generated between the coils and the magnets causes the rotor to rotate about the rotation axis A.

The speed reduction mechanism 20 is a device to reduce the speed of the rotational motion outputted from the motor 10. In the present preferred embodiment, the speed reduction mechanism 20 is arranged on the left side of the motor 10. The speed reduction mechanism 20 is arranged to reduce the speed of the rotational motion while transferring the rotational motion through a plurality of gears meshing with one another. As the speed reduction mechanism 20, a planetary gear mechanism including one sun gear and a plurality of planetary gears arranged around the sun gear, for example, is used. Note, however, that a mechanism other than the planetary gear mechanism may alternatively be used as the speed reduction mechanism 20. The speed-reduced rotational motion outputted from the speed reduction mechanism 20 is transferred to wheels of the vehicle directly or through another power transmission mechanism. Examples of the other power transmission mechanism include a differential mechanism to transfer the rotational motion to left and right wheels with a difference in speed.

The oil pump 30 is a device to feed an oil to each of the motor 10 and the speed reduction mechanism 20. That is, the oil pump 30 is an example of an auxiliary device to provide assistance in driving of the motor 10. The oil pump 30 is arranged, for example, on the lower side of the motor 10 or the speed reduction mechanism 20. The oil pump 30 is driven through supply of power from the power converter 40. Once the oil pump 30 is driven, the oil is fed to various portions of the motor 10 and the speed reduction mechanism 20. Lubrication between parts of the speed reduction mechanism 20 and the motor 10 and cooling of parts thereof are thus achieved.

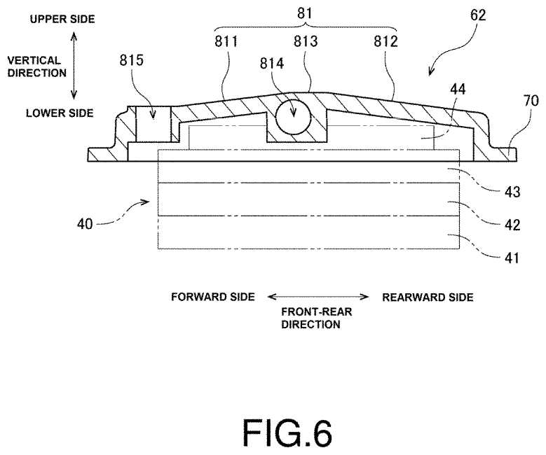

The power converter 40 is a device to convert power inputted from an outside, and supply the converted power to each of the motor 10 and the oil pump 30. In the present preferred embodiment, the power converter 40 is arranged rearward of and above the motor 10. FIG. 6 is a vertical sectional view of a second housing 62, which will be described below. The power converter 40 includes a circuit board 41, a capacitor 42, and an insulated-gate bipolar transistor (IGBT) 43 as represented by chain double-dashed lines in FIG. 6. The circuit board 41, the capacitor 42, and the IGBT 43 are each in the shape of a plate, and are placed one upon another in the vertical direction. The capacitor 42 is located on an upper side of the circuit board 41. The IGBT 43 is located on the upper side of the capacitor 42.

Each of the capacitor 42 and the IGBT 43 is electrically connected to an electrical circuit formed on the circuit board 41. Then, the electrical circuit on the circuit board 41, the capacitor 42, and the IGBT 43 are arranged to together form an inverter to convert power from direct current into alternating current. The power converter 40 is arranged to convert the power inputted from the outside through the electrical component 50 from direct current into alternating current using the inverter. Electric drive currents obtained by the conversion are supplied to the motor 10 and the oil pump 30.

The electrical component 50 is a component arranged to achieve electrical connection between input terminals 51 for an external power supply and the power converter 40. The electrical component 50 includes, for example, a bus bar and a switching circuit. In the present preferred embodiment, the electrical component 50 is arranged on the left side of the power converter 40. Power inputted from the external power supply to the input terminals 51 is supplied to the power converter 40 through the electrical component 50.

The housing 60 is a casing to house therein the motor 10, the speed reduction mechanism 20, the oil pump 30, the power converter 40, and the electrical component 50 described above. Referring to FIGS. 1 to 5, the housing 60 according to the present preferred embodiment includes a first housing 61, the second housing 62, and a third housing 63. Each of the first housing 61, the second housing 62, and the third housing 63 is a casting obtained by pouring a molten metal into a mold and hardening the molten metal therein. Each of the first housing 61, the second housing 62, and the third housing 63 is made of a metal such as, for example, aluminum or an aluminum alloy.

The first housing 61 is a casing to house the motor 10. The first housing 61 includes an opening at a rear portion of an upper surface thereof. The second housing 62 is arranged to cover this opening of the first housing 61. In addition, the second housing 62 is arranged to hold the power converter 40 between the first housing 61 and the second housing 62. Specifically, as illustrated in FIG. 6, the power converter 40 is fixed to a lower surface of the second housing 62 with a heat sink 44 therebetween. In addition, the electrical component 50 is also fixed to the lower surface of the second housing 62. The third housing 63 is a casing to house the speed reduction mechanism 20. The third housing 63 is fixed to a left-side side surface of the first housing 61.

Next, the detailed structure of the second housing 62 will now be described below.

Referring to FIGS. 1 to 5, the second housing 62 includes a peripheral portion 70 and a top/bottom portion 80. The peripheral portion 70 is a loop-shaped portion arranged to extend along a periphery of the second housing 62. The peripheral portion 70 includes a plurality of fastening holes 71. Each fastening hole 71 is arranged to pass through the peripheral portion 70 in the vertical direction. In addition, the first housing 61 includes a screw hole under each fastening hole 71. When the drive apparatus 1 is manufactured, a bolt (not shown) is passed through each fastening hole 71, and is fastened in the corresponding screw hole of the first housing 61. The second housing 62 is thus fixed to the first housing 61.

The top/bottom portion 80 is a portion arranged to extend inside of the peripheral portion 70. An upper surface of the power converter 40 is covered with the top/bottom portion 80. The top/bottom portion 80 is arranged to extend substantially in the shape of a plate, extending in both the left-right direction and the front-rear direction. Note that, if the top/bottom portion 60 were completely in the shape of a thin flat plate, the top/bottom portion 80 would vibrate to cause noise. Accordingly, the second housing 62 according to the present preferred embodiment is arranged to have a non-flat vibration suppression structure. This reduces or eliminates vibration of the top/bottom portion 80 when the vehicle is traveling. As a result, a reduction in noise of the drive apparatus 1 is achieved.

The top/bottom portion 80 of the second housing 62 includes a main plate portion 81 and a subsidiary plate portion 82. The subsidiary plate portion 82 is located on the left side of the main plate portion 81. The main plate portion 81 is located on the upper side of the power converter 40. That is, the main plate portion 81 is arranged to cover an upper portion of the power converter 40. The subsidiary plate portion 82 is located on the upper side of the electrical component 50. That is, the subsidiary plate portion 82 is arranged to cover an upper portion of the electrical component 50.

An upper surface of the main plate portion 81, which is an outer surface of the main plate portion 81, includes a first surface 811, a second surface 812, and a boundary surface 813. The boundary surface 813 is arranged to extend in the shape of a strip in the left-right direction near a middle of the main plate portion 81 in the front-rear direction. The boundary surface 813 is arranged to extend perpendicularly to the vertical direction. The first surface 811 is located on a forward side of the boundary surface 813. The first surface 811 is a slanting surface arranged to gradually decrease in height while extending forward from the boundary surface 813. The second surface 812 is located on a rearward side of the boundary surface 813. The second surface 812 is a slanting surface arranged to gradually decrease in height while extending rearward from the boundary surface 813.

As described above, the vibration suppression structure according to the present preferred embodiment includes the first surface 811, the second surface 812, and the boundary surface 813 arranged at mutually different angles. Each of these surfaces 811, 812, and 813 allows a vibration to propagate in a different direction therethrough. Thus, with the outer surface of the main plate portion 81 including the plurality of surfaces arranged at mutually different angles, sympathetic vibration of the main plate portion 81 is reduced or prevented. The vibration of the top/bottom portion 80 is thus reduced or eliminated, resulting in a reduction in noise that accompanies vibration.

Note that the boundary surface 813 may be omitted. That is, the first surface 811 and the second surface 812 may alternatively be arranged adjacent to each other in the front-rear direction without an intervening surface. Also note that the first surface 811 and the second surface 812 may alternatively be arranged adjacent to each other in the left-right direction. Also note that one of the first surface 811 and the second surface 812 may alternatively be a surface extending perpendicularly to the vertical direction. Also note that the upper surface of the main plate portion 81 may include another surface that serves as a portion of the vibration suppression structure, in addition to the first surface 811, the second surface 812, and the boundary surface 813. That is, it may be sufficient if the upper surface of the main plate portion 81, which has a vibration suppression structure, includes at least two surfaces arranged at mutually different angles.

In particular, in the present preferred embodiment, each of the first surface 811, the second surface 812, and the boundary surface 813 is arranged to have a different size. Specifically, a dimension of the first surface 811 in the front-rear direction, a dimension of the second surface 812 in the front-rear direction, and a dimension of the boundary surface 813 in the front-rear direction are different from one another. Accordingly, each of these surfaces 811, 812, and 813 has a different natural frequency. Thus, differences in dimensions of the surfaces 811, 812, and 813 contribute to more effectively preventing sympathetic vibrations of the surfaces 811, 812, and 813. This in turn leads to additional reductions in vibration and noise of the top/bottom portion 80.

In addition, as illustrated in FIG. 3, a portion of a rear-side edge portion of the second surface 812 includes an arc portion 812a recessed forward in the shape of an arc to avoid one of the fastening holes 71. Further, a portion of a right-side edge portion of the first surface 811 includes an arc portion 811a recessed to the left in the shape of an arc to avoid one of the fastening holes 71. Still further, a portion of a left-side edge portion of the first surface 811 includes an arc portion 811b recessed to the right in the shape of an arc to avoid one of the fastening holes 71. Thus, even within each of the first surface 811 and the second surface 812, there is a portion having a different dimension in the front-rear direction, or a portion having a different dimension in the left-right direction. That is, even within each of the first surface 811 and the second surface 812 considered in isolation, there is a portion having a different natural frequency. Thus, different dimensions within each of the surfaces 811 and 812 contribute to more effectively preventing a sympathetic vibration in each of the surfaces 811 and 812. This in turn leads to additional reductions in vibration and noise of the top/bottom portion 80. Provision of the arc portions 811a, 811b, and 812a each recessed in the shape of an arc, rather than projecting portions projecting outward, contributes to preventing or reducing an increase in size of the second housing 62. This in turn contributes to preventing or reducing an increase in size of the drive apparatus 1.

The main plate portion 81 includes a flow passage 814 through which a cooling medium passes as represented by a broken line in FIG. 3. Water, for example, is used as the cooling medium. The flow passage 814 includes an approach passage 814a and a return passage 814b. An end portion of the approach passage 814a on an upstream side is arranged to have an opening in a right side surface of the main plate portion 81. The approach passage 814a is arranged to extend leftward from this opening to a left end portion of the main plate portion 81 under the boundary surface 813. The return passage 814b is located higher than the approach passage 814a, and is arranged to extend rightward from the left end portion of the main plate portion 81. An end portion of the return passage 814b on a downstream side is arranged to have an opening in the right side surface of the main plate portion 81.

As described above, the flow passage 814 is arranged to extend along a boundary between the first surface 811 and the second surface 812 arranged at mutually different angles. Thus, a space in the vicinity of the boundary between the first surface 811 and the second surface 812 can be effectively used as the flow passage 814. In the present preferred embodiment, the boundary between the first surface 811 and the second surface 812 extends parallel to the rotation axis A of the motor 10. Accordingly, the flow passage 814 also extends parallel to the rotation axis A of the motor 10.

When the drive apparatus 1 is used, the cooling medium is introduced into the flow passage 814. Thus, heat generated in the power converter 40 is absorbed by the cooling medium in the flow passage 814 through the heat sink 44. As a result, an excessive increase in temperature of the power converter 40 is prevented. In particular, in the present preferred embodiment, the flow passage 814 is arranged at a position close to an upper side of the IGBT 43, at which the temperature of the power converter 40 becomes highest. Thus, heat of the IGBT 43 can be efficiently absorbed by the cooling medium in the flow passage 814.

In addition, an outer surface of the top/bottom portion 80 includes a shoulder portion 83 at a boundary between the main plate portion 81 and the subsidiary plate portion 82. In the present preferred embodiment, an upper surface of the subsidiary plate portion 82 is located lower than the upper surface of the main plate portion 81. The shoulder portion 83 includes a shoulder surface arranged to extend in the vertical direction between a left end portion of the upper surface of the main plate portion 81 and a right end portion of the upper surface of the subsidiary plate portion 82.

The vibration suppression structure according to the present preferred embodiment includes the shoulder portion 83 as described above. The shoulder portion 83 contributes to preventing or reducing propagation of vibration from one side of the shoulder portion 83 to the other side. Thus, propagation of vibration from the main plate portion 81 to the subsidiary plate portion 82 is prevented or reduced. In addition, propagation of vibration from the subsidiary plate portion 82 to the main plate portion 81 is also prevented or reduced. The vibration of the top/bottom portion 80 is thus reduced or eliminated, resulting in a reduction in noise that accompanies vibration.

In addition, in the present preferred embodiment, the upper surface of the subsidiary plate portion 82, which is an outer surface of the subsidiary plate portion 82, includes a recessed portion 821. The recessed portion 821 is recessed downward from the upper surface of the subsidiary plate portion 82. In addition, the recessed portion 821 is arranged to extend in the left-right direction from the right end portion to a left end portion of the upper surface of the subsidiary plate portion 82. The vibration suppression structure according to the present preferred embodiment includes the recessed portion 821 as described above. Thus, when a vibration propagates in the top/bottom portion 80, the direction of the propagation of the vibration changes at the position of the recessed portion 821. This leads to an additional reduction in the vibration of the top/bottom portion 80. This in turn leads to an additional reduction in noise that accompanies vibration.

In particular, the recessed portion 821 according to the present preferred embodiment is defined by a recessed curved surface. Specifically, the recessed portion 821 is defined by a curved surface in the shape of an arc when viewed in the left-right direction. A curved surface tends to more easily attenuate a vibration than a flat surface. Accordingly, the recessed portion 821 according to the present preferred embodiment is able to attenuate a vibration to a greater degree than a recessed portion defined by a combination of flat surfaces. Thus, additional reductions in the vibration and noise of the top/bottom portion 80 can be achieved.

In addition, as illustrated in FIG. 3, the recessed portion 821 according to the present preferred embodiment is arranged to extend in the left-right direction at the same position in the front-rear direction as the above-described flow passage 814. That is, the recessed portion 821 and the flow passage 814 are arranged on the same straight line. Accordingly, it is possible to move a cutting tool using a space within the recessed portion 821 when defining the flow passage 814 by a cutting process in a process of manufacturing the second housing 62. Accordingly, it is easy to define the flow passage 814 extending in the left-right direction in the main plate portion 81.

In addition, as illustrated in FIG. 6, the top/bottom portion 80 of the second housing 62 includes a through hole 815. The through hole 815 is arranged to pass through the main plate portion 81 in the vertical direction at a position in a forward portion of the first surface 811. When the drive apparatus 1 is manufactured, an operation for establishing electrical connections for the power converter 40 is performed through the through hole 815 after the second housing 62 is fixed to the first housing 61. Then, after this connecting operation is completed, an upper portion of the through hole 815 is closed with a plate 90.

The plate 90 is fixed to the main plate portion 81 through bolting. Accordingly, a portion of the main plate portion 81 near and around the through hole 815 is arranged to have a thickness in the vertical direction greater than that of a remaining portion of the main plate portion 81. In addition, a portion of the main plate portion 81 near and around the flow passage 814 is also arranged to have a thickness in the vertical direction greater than that of a remaining portion of the main plate portion 81. That is, the main plate portion 81 includes a decreased thickness portion and increased thickness portions. When the thickness of the top/bottom portion 80 in the vertical direction is uneven as described above, the decreased thickness portion and the increased thickness portions have different natural frequencies. This contributes to more effectively preventing a sympathetic vibration of the top/bottom portion 80. As a result, the vibration of the top/bottom portion 80 is reduced or eliminated, resulting in a reduction in noise caused by vibration.

In addition, as illustrated in FIG. 3, the fastening holes 71 are arranged at irregular intervals in the peripheral portion 70 of the second housing 62. That is, the bolts used to fix the second housing 62 to the first housing 61 are arranged at irregular intervals along the peripheral portion 70 of the second housing 62. Thus, portions of the peripheral portion 70 between adjacent ones of the fastening holes 71 have different natural frequencies. This contributes to more effectively preventing a sympathetic vibration of the second housing 62. This leads to additional reductions in vibration and noise of the second housing 62.

A portion of the second housing 62 which lies under the recessed portion 821 has a particularly small thickness in the vertical direction. However, in the present preferred embodiment, two of the fastening holes 71 are arranged at a position forward of and close to the recessed portion 821 and a position rearward of and close to the recessed portion 821, respectively. That is, the recessed portion 821 is located between positions at which a pair of bolts achieve fastening. Thus, a vibration in the vicinity of the recessed portion 821 can be reduced or eliminated.

As described above, the second housing 62 according to the present preferred embodiment includes a variety of vibration suppression structures. Accordingly, the second housing 62 is able to reduce or eliminate a vibration when the vehicle is traveling despite having a flat shape and being arranged to close the opening of the first housing 61. In addition, the second housing 62 has both a function of closing the opening of the first housing 61 as a cover, and a function of holding the power converter 40. Thus, a reduction in the size of the drive apparatus 1 can be more easily achieved than in the case where a plurality of members are prepared to implement these functions.

While a preferred embodiment of the present invention has been described above, it will be understood that the present invention is not limited to the above-described preferred embodiment.

For example, in the above-described preferred embodiment, the flow passage 814 includes the approach passage 614a and the return passage 814b, and both an end portion of the flow passage 814 on the upstream side and an end portion of the flow passage 814 on the downstream side are located in the right side surface of the main plate portion 81. Note, however, that the flow passage 814 may alternatively include only the approach passage 814a. In this case, the end portion of the flow passage 814 on the downstream side may be located in a left side surface of the main plate portion 81.

In the above-described preferred embodiment, the power converter 40 includes the inverter to convert direct current into alternating current. Note, however, that the power converter 40 may include an inverter to convert alternating current to alternating current of a different frequency. Also note that the power converter 40 may include, instead of an inverter, a DC-DC converter to convert direct current to direct current of a different voltage.

The drive apparatus 1 according to the above-described preferred embodiment is installed in a vehicle such as, for example, an electric vehicle or a plug-in hybrid vehicle. Note, however, that drive apparatuses having equivalent structures according to other preferred embodiments of the present invention may be installed in other types of vehicles, such as, for example, two-wheeled vehicles or railway vehicles. Also note that drive apparatuses having equivalent structures according to other preferred embodiments of the present invention may be installed in flying apparatuses, such as, for example, drones or airplanes. In short, a drive apparatus according to a preferred embodiment of the present invention may be installed in any desirable movable body that involves a vibration.

Note that the detailed shape of any member may be different from the shape thereof as illustrated in the accompanying drawings of the present application. Also note that features of the above-described preferred embodiments and the modifications thereof may be combined appropriately as long as no conflict arises.

Preferred embodiments of the present invention are applicable to drive apparatuses.

What is claimed is:

1. A drive apparatus comprising:
a motor;
a speed reduction mechanism arranged to reduce a speed of rotational motion outputted from the motor;
a power converter arranged to convert power inputted from an outside, and supply the converted power to the motor; and
a housing arranged to house the motor, the speed reduction mechanism, and the power converter; wherein
the housing includes:
a first housing arranged to house the motor, and including an opening; and
a second housing arranged to cover the opening of the first housing, and hold the power converter between the first housing and the second housing;
the second housing includes:
a peripheral portion fixed to the first housing; and
a bottom portion arranged to extend inside of the peripheral portion; and
the bottom portion is arranged to have a non-flat vibration suppression structure.

2. The drive apparatus according to claim 1, further comprising an electrical component electrically connected to the power converter, wherein the bottom portion includes:
a main plate portion arranged to cover the power converter; and
a subsidiary plate portion arranged to cover the electrical component.

3. The drive apparatus according to claim 2, wherein the vibration suppression structure includes a first surface and a second surface included in an outer surface of the bottom portion and arranged at mutually different angles.

4. The drive apparatus according to claim 3, wherein each of the first surface and the second surface is included in an outer surface of the main plate portion.

5. The drive apparatus according to claim 4, wherein
the main plate portion includes a flow passage through which a cooling medium passes; and
the flow passage is arranged to extend along a boundary between the first surface and the second surface.

6. The drive apparatus according to claim 3, wherein a boundary between the first surface and the second surface is arranged to extend parallel to a rotation axis of the motor.

7. The drive apparatus according to claim 2, wherein the vibration suppression structure includes a shoulder portion defined in the outer surface of the bottom portion.

8. The drive apparatus according to claim 7, wherein the shoulder portion is located at a boundary between the main plate portion and the subsidiary plate portion.

9. The drive apparatus according to claim 5, wherein the vibration suppression structure includes a recessed portion defined in the outer surface of the bottom portion.

10. The drive apparatus according to claim 9, wherein the recessed portion is defined in an outer surface of the subsidiary plate portion.

11. The drive apparatus according to claim 9, wherein the recessed portion includes a curved surface.

12. The drive apparatus according to claim 9, wherein the flow passage and the recessed portion are arranged on the same straight line.

13. The drive apparatus according to claim 1, wherein a thickness of the bottom portion is uneven.

14. The drive apparatus according to claim 1, wherein each of the first housing and the second housing is a casting.

15. The drive apparatus according to claim 1, further comprising a third housing arranged to house the speed reduction mechanism.

16. The drive apparatus according to claim 1, further comprising an auxiliary device to provide assistance in driving of the motor, wherein the auxiliary device is arranged to be driven through supply of power from the power converter.

17. The drive apparatus according to claim 1, wherein the power converter includes an inverter to convert direct current into alternating current.

18. The drive apparatus according to claim 1, wherein the drive apparatus is to be installed in a vehicle to output a driving force to cause the vehicle to travel.
